(19) United States
(12) Patent Application Publication
(10) Pub. No.: US 2013/0269024 A1
(43) Pub. Date: Oct. 10, 2013

(54) ELECTRONIC DEVICE AND METHOD FOR CONTROLLING ACCESS TO THE ELECTRONIC DEVICE

(71) Applicant: HON HAI PRECISION INDUSTRY CO., LTD., New Taipei (TW)

(72) Inventors: CHUI-WEN CHIU, New Taipei (TW); CHEN-LIANG LIANG, New Taipei (TW)

(73) Assignee: HON HAI PRECISION INDUSTRY CO., LTD., New Taipei (TW)

(21) Appl. No.: 13/706,427

(22) Filed: Dec. 6, 2012

(30) Foreign Application Priority Data
Apr. 5, 2012 (TW) 101111983

(51) Int. Cl. G06F 21/00

(52) U.S. Cl. CPC G06F 21/00
USPC 726/16

(57) ABSTRACT

A method for controlling access to an electronic device, the electronic device determines one or more selected colored shapes in response to receiving selection signals generated by a user selecting the one or more colored shapes, sequentially numbers the selected colored shapes to obtain numbering information. When the numbering information matches prestored unlocking numbering information, the electronic device is unlocked.

### BACKGROUND

1. Technical Field

Embodiments of the present disclosure relate to access technology, and particularly to an electronic device and a method for controlling access to the electronic device.

2. Description of Related Art

An electronic device (e.g., a mobile phone) may be accessed using a slide operation on a display of the electronic device. However, this kind of access method cannot ensure the safety of information stored in the electronic device. Therefore, a method for controlling access to an electronic device to prevent unauthorized access to data is desired.

### BRIEF DESCRIPTION OF THE DRAWINGS

FIG. 1 is a block diagram of one embodiment of an electronic device including an unlocking system.

FIG. 2 is a block diagram of function modules of the unlocking system included in the electronic device.

FIG. 3 is a flowchart of one embodiment of a method for unlocking the electronic device.

FIG. 4A-4C are schematic diagrams showing successive steps in one example of creating colored shapes, according to the method of FIG. 3.

FIG. 5 is a schematic diagram of unlocking the electronic device according to the method of FIG. 3.

### DETAILED DESCRIPTION

All of the processes described below may be embodied in, and fully automated via, functional code modules executed by one or more general purpose electronic devices or processors. The functional code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

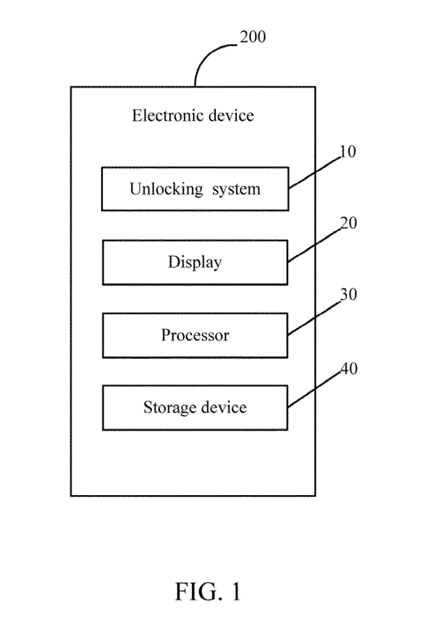

FIG. 1 is a block diagram of one embodiment of an electronic device 200 including an unlocking system 10. The electronic device 200 further includes a display 20, at least one processor 30, and a storage device 40. The electronic device 200 may be a smart phone, a personal digital assistant (PDA), or any other computing device. It should be understood that FIG. 1 illustrates merely one example of the electronic device 200. The electronic device 200 may include more or fewer components than illustrated, or have a different configuration of the various components in other embodiments.

The display 20 may be, for example, a touch panel which supports multi-touch, such as a resistive touch panel or a capacitive touch panel for receiving input. In this and other embodiments, input may be by other means such as keypad or mouse. Herein clicking refers to selections made by any input means such as using a mouse to point at a selection and clicking a mouse button, or selections made by a user touching the appropriate spot on the touch screen.

The storage device 40 may be a non-volatile computer storage chip that can be electrically erased and reprogrammed, such as a flash memory card. In general terms, the unlocking system 10 allows a user to control access to the electronic device 200 by allowing the user to set an access password comprised of colored shapes in a particular order. Then, once locked, the electronic device 200 can only be accessed when the sequence of colored shapes chosen by the user are correctly inputted. Details for selecting and using the access password are described below.

In one embodiment, the unlocking system 10 may include computerized instructions in the form of one or more programs that are executed by the at least one processor 30 and stored in the storage device 40. A detailed description of the unlocking system 10 will be given in the following paragraphs.

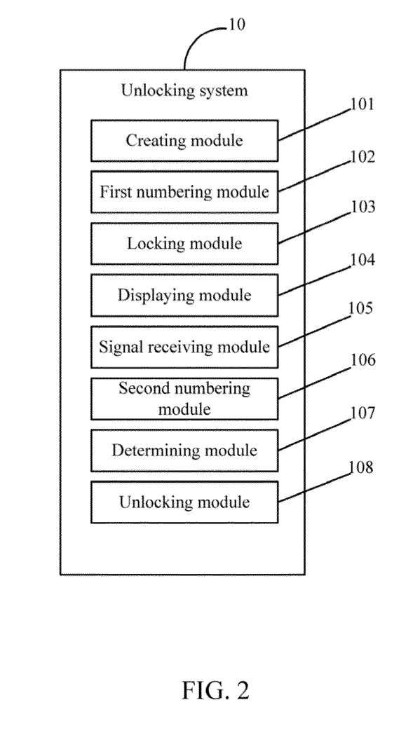

FIG. 2 is a block diagram of function modules of the unlocking system 10 in the electronic device 200. In one embodiment, the unlocking system 10 may include one or more modules, for example, a creating module 101, a first numbering module 102, a locking module 103, a displaying module 104, a signal receiving module 105, a second numbering module 106, a determination module 107, and an unlocking module 108.

In general, the word “module,” as used herein, refers to logic embodied in hardware or firmware, or to a collection of software instructions, written in a programming language, such as Java, C, or assembly. One or more software instructions in the modules may be embedded in firmware, such as in an erasable-programmable read-only memory (EPROM). The modules described herein may be implemented as either software and/or hardware modules and may be stored in any type of non-transitory computer-readable medium or other storage device. Some non-limiting examples of non-transitory computer-readable mediums include compact disc (CDs), digital versatile discs (DVDs), Blue-Ray disks, flash memory, and hard disk drives.

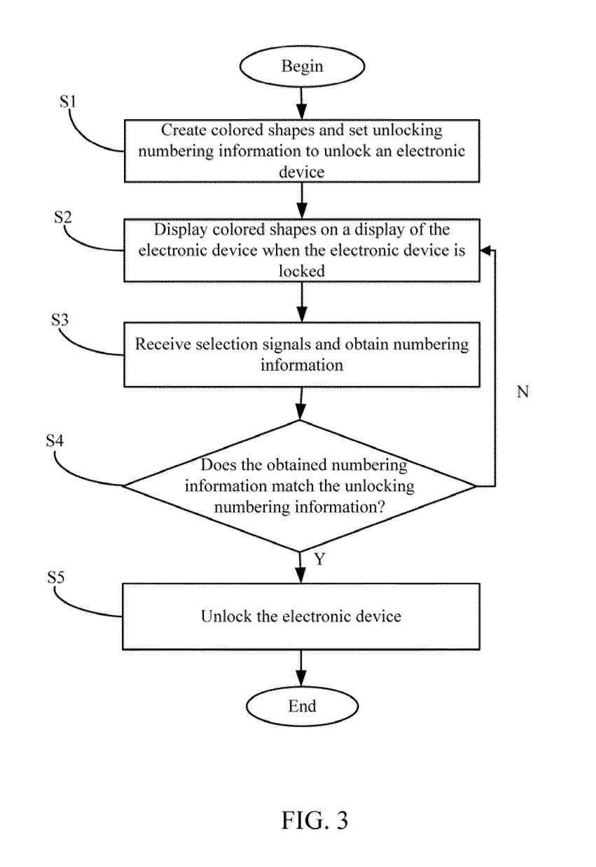

FIG. 3 is a flowchart of one embodiment of a method for unlocking the electronic device 200. Depending on the embodiment, additional steps may be added, others removed, and the ordering of the steps may be changed.

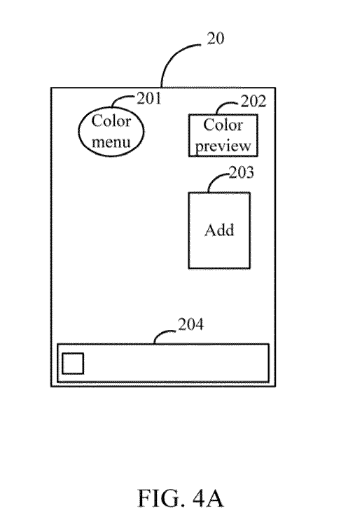

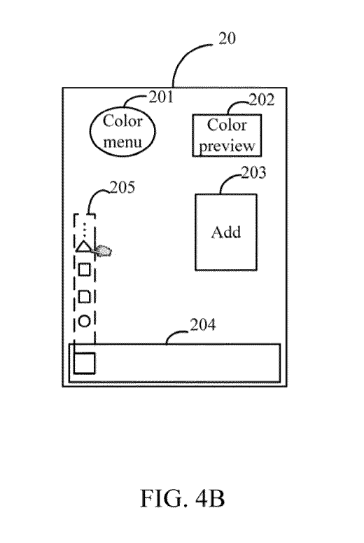

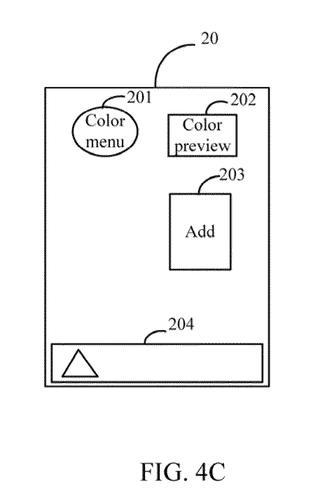

In step S1, the creating module 101 creates a plurality of colored shapes. For example, the colored shapes may be figures having different shapes and/or colors. As shown in FIG. 4A, the creating module 101 may generate a color menu 201 including a number of colors such as red, green, orange, yellow, and blue. The creating module 101 further generates a color preview window 202 to preview a color selected from the color menu 201 by the user, generates an add button/icon 203 to generate a figure in the selected color, and a first window 204 to present the generated figure. In one embodiment, the creating module 101 sets a square as an initial shape for the generated figure, in other embodiments, the creating module 101 may set other initial shapes such as a triangle and/or a circle.

An example of generating a red square is provided as follows. First, the user selects the red color from the color menu 201, and the red color is previewed in the color preview window 202. Then the first window 204 presents a generated red square when the add button/icon 203 selected by the user, that is, a red square is created. A plurality of colored shapes can be created according to the exemplary method.

If the user wants to change the shape of the generated figure, as shown in FIG. 4B, the user may press and hold the generated figure such as the red square for a predetermined time (e.g., two seconds), then a drop-up menu 205 is presented to provide a variety of shapes, such as the square, the triangle, a rhombus etc., for the user to choose. For example, if the user selects the triangle from the drop-up menu 205, the red square will be changed to be a red triangle (as shown in FIG. 4C). the drop-up menu 205 will have an option to allow the user to create his/her own shape. For example, the user may create the red triangle, an orange square, a yellow circle and a green heart-shaped figure.

The first numbering module 102 sequentially numbers one or more created colored shapes to obtain unlocking numbering information, and stores the unlocking numbering information in the storage device 40. In one embodiment, the user may have at least 3 colored shapes to create the unlocking numbering information for the electronic device 200 to make it hard to be cracked. For example, the first numbering module 102 numbers 3 of the created colored shapes, obtains the unlocking numbering information likes “the orange square is number 1, the red triangle is number 2, and the yellow circle is number 3”, and stores the unlocking numbering information in the storage device 40.

In other embodiments, more colored shapes may be created, and more created colored shapes may be numbered to predetermine the unlocking numbering information. The locking module 103 locks the electronic device 200 when the electronic device 200 is in a standby state for a predetermined time period (such as 1 minute).

In step S2, the displaying module 104 displays the created colored shapes on the display 20 when the electronic device 200 is locked. For example, the displaying module 104 displays the created colored shapes such as the red triangle, the orange square, the yellow circle, and the green heart-shaped figure in random order on the display 20.

In step S3, the signal receiving module 105 determines one or more sequentially selected colored shapes on the display 20 in response to receiving selection signals generated by the user selecting the one or more colored shapes The second numbering module 106 sequentially numbers the selected colored shapes according to a selection order, to obtain numbering information. In one embodiment, the displaying module 104 displays a corresponding number on the selected colored shapes according to the selection order and highlights the selected colored shapes when the second numbering module 106 numbers the selected colored shapes.

In other embodiments, the displaying module 104 displays a corresponding number on the selected colored shapes according to the selection order when the second numbering module 106 numbers the selected colored shapes, and provides a second window 206 on the display 20 to present the selected colored shapes in the selection order.

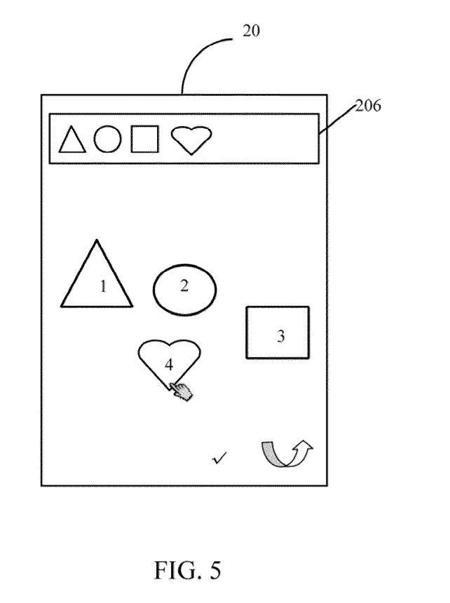

For example, as shown in FIG. 5, the signal receiving module 105 receives a first selection signal when the user selects the red triangle, and determines that the red triangle is the selected colored shape, and the second numbering module 106 numbers the red triangle as number 1. Then the displaying module 104 displays a corresponding number such as “1” on the red triangle, and presents the red triangle on the second window 206.

The signal receiving module 105 receives a second selection signal when the user selects the yellow circle, and determines that the yellow circle is the selected colored shape, and the second numbering module 106 numbers the yellow circle as number 2, i.e., the second numbering module 106 numbers the selected colored shapes according to the selection order that the user selects the colored shape. The displaying module 104 displays the corresponding number such as “2” on the yellow circle, and presents the yellow circle next to the red triangle on the second window 206, i.e., the displaying module 104 presents the selected colored shapes according to the selection order.

Then, the second numbering module 106 obtains numbering information like “the red triangle is number 1, the yellow circle is number 2, the orange square is number 3, the green heart-shaped figure is number 4”. The user submits the obtained numbering information by selecting a submitting button “√” to unlock the electronic device 200. If the user selected wrong colored shape(s), the user may select a retry button “ [symbol] ” to restart the unlock operation.

In step S4, the determining module 107 determines whether the obtained numbering information matches the unlocking numbering information prestored in the storage device 40. If the obtained numbering information matches the unlocking numbering information, the procedure goes to step S5, otherwise, if the obtained numbering information doest not match the unlocking numbering information, the procedure returns to step S2.

For example, when the determining module 107 determines that the obtained numbering information “the red triangle is number 1, the yellow circle is number 2, the orange square is number 3, the green heart-shaped figure is number 4” does not match the unlocking numbering information “the orange square is number 1, the red triangle is number 2, and the yellow circle is number 3”, the procedure returns to step S2.

In step S5, the unlocking module 108 unlocks electronic device 200.

It should be emphasized that the above-described embodiments are merely possible examples of implementations, set forth for a clear understanding of the principles of the disclosure. Many variations and modifications may be made to the above-described embodiments without departing substantially from the spirit and principles of the disclosure. All such modifications and variations are intended to be included herein within the scope of this disclosure and may be protected by the following claims.

What is claimed is:

1. An electronic device, comprising:
a display;
a storage device;
at least one processor; and
one or more modules stored in the storage device and executable by the at least one processor, the one or more modules comprising:
a displaying module that displays a plurality of colored shapes on the display of the electronic device when the electronic device is locked;
a signal receiving module that determines one or more sequentially selected colored shapes on the display in response to receiving selection signals generated by a user selecting the one or more colored shapes;
a second numbering module that sequentially numbers the selected colored shapes according to a selection order of the selected colored shapes to obtain numbering information;
a determining module that determines whether the obtained numbering information matches unlocking numbering information prestored in the storage device; and
an unlocking module that unlocks the electronic device upon the condition that the obtained numbering information matches the unlocking numbering information.

2. The electronic device according to claim 1, wherein the one or more modules further comprise:
a creating module that creates the plurality of colored shapes;
a first numbering module that sequentially numbers one or more created colored shapes to obtain the unlocking numbering information and stores the unlocking numbering information in the storage device; and
a locking module that locks the electronic device when the electronic device is in a standby state for a predetermined time period.

3. The electronic device according to claim 2, wherein the colored shapes are figures having different shapes and/or colors.

4. The electronic device according to claim 1, wherein the displaying module further displays a corresponding number on the selected colored shapes according to the selection order and highlights the selected colored shapes when the second numbering module numbers the selected colored shapes.

5. The electronic device according to claim 1, wherein the displaying module further displays a corresponding number on the selected colored shapes according to the selection order and provides a window on the display to present the selected colored shapes in the selection order when the second numbering module numbers the selected colored shapes.

6. A computer-implemented method for controlling access to an electronic device, the electronic device comprising a display, a storage device, and a processor, the method comprising:
step (a): displaying a plurality of colored shapes on the display of the electronic device when the electronic device is locked;
step (b): determines one or more sequentially selected colored shapes on the display in response to receiving selection signals generated by a user selecting the one or more colored shapes;
step (c): sequentially numbering the selected colored shapes according to a selection order of the selected colored shapes to obtain numbering information;
step (d): determining whether the obtained numbering information matches unlocking numbering information prestored in the storage device, if the obtained numbering information matches the unlocking numbering information, the process goes to step 5, if the obtained numbering information doesn't match the unlocking numbering information, the process ends; and
step (e): unlocking the electronic device upon the condition that the obtained numbering information matches the unlocking numbering information.

7. The method according to claim 6, further comprising:
step (f): creating the plurality of colored shapes;
step (g): sequentially numbering one or more created colored shapes to obtain the unlocking numbering information and stores the unlocking numbering information in the storage device; and
step (h): locking the electronic device when the electronic device is in a standby state for a predetermined time period.

8. The method according to claim 7, wherein the colored shapes are figures having different shapes and/or colors.

9. The method according to claim 6, further comprising:
step (i): displaying a corresponding number on the selected colored shapes according to the selection order and highlights the selected colored shapes when numbers the selected colored shapes.

10. The method according to claim 6, further comprising:
step (j): displaying a corresponding number on the selected colored shapes according to the selection order and provides a window on the display to present the selected colored shapes in the selection order when numbers the selected colored shapes.

11. A non-transitory storage medium having stored thereon instructions that, when executed by a processor of an electronic device, causes the electronic device to perform a method for controlling access to the electronic device, the electronic device further comprising a display, and a storage device, the method comprising:
step (a): displaying a plurality of colored shapes on the display of the electronic device when the electronic device is locked;
step (b): determines one or more sequentially selected colored shapes on the display in response to receiving selection signals generated by a user selecting the one or more colored shapes;
step (c): sequentially numbering the selected colored shapes according to a selection order of the selected colored shapes to obtain numbering information;
step (d): determining whether the obtained numbering information matches unlocking numbering information prestored in the storage device, if the obtained numbering information matches the unlocking numbering information, the process goes to step 5, if the obtained numbering information doesn't match the unlocking numbering information, the process ends; and
step (e): unlocking the electronic device upon the condition that the obtained numbering information matches the unlocking numbering information.

12. The non-transitory storage medium according to claim 11, wherein the method further comprises:
step (f): creating the plurality of colored shapes;
step (g): sequentially numbering one or more created colored shapes to obtain the unlocking numbering information and stores the unlocking numbering information in the storage device; and
step (h): locking the electronic device when the electronic device is in a standby state for a predetermined time period.

13. The non-transitory storage medium according to claim 12, wherein the colored shapes are figures having different shapes and/or colors.

14. The non-transitory storage medium according to claim 11, further comprising:
step (i): displaying a corresponding number on the selected colored shapes according to the selection order and highlights the selected colored shapes when numbers the selected colored shapes.

15. The non-transitory storage medium according to claim 11, further comprising:
step (j): displaying a corresponding number on the selected colored shapes according to the selection order and provides a window on the display to present the selected colored shapes in the selection order when numbers the selected colored shapes.
